(19) United States
(12) Patent Application Publication
(10) Pub. No.: US 2014/0330451 A1
(43) Pub. Date: Nov. 6, 2014

(54) APPARATUS FOR MANAGING REFLECTING PLATE FOR FRUIT TREE AND METHOD USING THE SAME

(71) Applicant: Electronics and Telecommunications Research Institute, Daejeon-city (KR)

(72) Inventors: Sang-Ho LEE, Daegu (KR); Jang-Sik BAE, Daegu (KR); Kyu-Hyung KIM, Daegu (KR); Song LI, Daegu (KR); Soo-In LEE, Daejeon (KR)

(73) Assignee: Electronics and Telecommunications Research Institute, Daejeon-city (KR)

(21) Appl. No.: 14/248,387

(22) Filed: Apr. 9, 2014

(30) Foreign Application Priority Data
May 3, 2013 (KR) 10-2013-0049973

(51) Int. Cl. G05D 1/00; A01G 7/04; G02B 7/182; B25J 13/00

(52) U.S. Cl. CPC G05D 1/0022; B25J 13/006; A01G 7/04; G02B 7/182
USPC 701/2; 359/881

(57) ABSTRACT

An apparatus and a method for managing a reflecting plate for a fruit tree are disclosed. The apparatus for managing a reflecting plate for a fruit tree includes: a solar sensor configured to sense the amount of sunlight; a fruit-tree database configured to store therein types and locations of fruit trees grown in a growing area; a wireless communication unit configured to perform communications with a robot for moving a reflecting plate for a fruit tree and with the reflecting plate via a wireless communication network; and a central processing unit configured to control the robot so that it installs the reflecting plate in the growing area and to control a reflection angle at which the sunlight is reflected in the reflecting plate, based on at least one of the amount of sunlight, the types and locations.

### CROSS REFERENCE TO RELATED APPLICATION

This application claims priority to and the benefit of Korean Patent Application No. 10-2013-0049973, filed on May 3, 2013, which is hereby incorporated by reference in its entirety.

### BACKGROUND OF THE INVENTION

1. Technical Field

The present invention generally relates to an apparatus and a method for managing a reflecting plate for facilitating the growth of a fruit tree, and more particularly, to an apparatus and a method for managing a reflecting plate that are capable of advance fruit maturity and improve fruit quality by way of reflecting sunlight incident on the surface of the earth to increase the amount of sunlight toward fruits.

2. Description of the Related Art

In fruit farms, in order to make the colors of fruit better or make fruits sweeter in the harvest season, or in order to advance fruit maturity, farmers lays aluminum foils on the surface of the earth so that sunlight incident thereon is reflected to increase the amount of sunlight toward fruits.

However, it is very cumbersome for farmers to lay the aluminum foils on the surface. Further, the laid aluminum foils are to be discarded after the harvest. That is, the aluminum foils are not reusable but are expendable after harvest, and thus waste of the aluminum foils cause serious environmental problems.

Further, since the incident angle of sunlight continuously varies as the Sun moves, it is not possible to efficiently increase the amount of sunlight toward fruits with fixed aluminum foils.

Japanese Patent Laid-Open Publication No. 1993-328848 discloses a lighting apparatus for fruits in a greenhouse. The lighting apparatus disclosed in the document includes lighting devices disposed among fruit trees in a greenhouse, which are rotatable to change illumination angles, and the illumination angles of the lighting devices can be adjusted by control means.

However, the lighting apparatus disclosed in the document is irrelevant to reflecting sunlight to increase the amount of sunlight toward fruits and has a critical problem in that it is very cumbersome to install a large number of lighting apparatuses in a broad fruit farm.

Therefore, a novel technique to increase the amount of sunlight toward fruit is required.

### SUMMARY OF THE INVENTION

Accordingly, the present invention has been made keeping in mind the above problems occurring in the conventional art, and an object of the present invention is to efficiently increase the amount of sunlight toward fruits by way of efficiently install reflecting plates throughout a broad fruit farm and adjusting the angles of the reflecting plates in accordance with the incident angle of sunlight.

Another object of the present invention is to reduce environmental pollution by reusing a reflecting plate used for increasing the amount of sunlight toward fruits.

Yet another object of the present invention is to increase earnings of fruit farms by way of saving labor cost required for installing reflecting plates

In accordance with an aspect of the present invention, there is provided an apparatus for managing a reflecting plate for a fruit tree, including: a solar sensor configured to sense the amount of sunlight; a fruit-tree database configured to store therein types and locations of fruit trees grown in a growing area; a wireless communication unit configured to perform communications with a robot for moving a reflecting plate for a fruit tree and with the reflecting plate via a wireless communication network; and a central processing unit configured to control the robot so that it installs the reflecting plate in the growing area and to control a reflection angle at which the sunlight is reflected in the reflecting plate, based on at least one of the amount of sunlight, the types and locations.

The apparatus may determine whether to install the reflecting plate based on the amount of sunlight.

The apparatus may determine the number and locations of reflecting plates to be installed for each of the types, based on at least one of the amount of sunlight, the types and locations.

The robot may collect location information via a GPS device and transmits to the apparatus at least one of a location where the reflecting plate is installed and a direction in which the reflecting plate heads for.

The reflecting plate may have on a surface thereof a reflecting part to reflect the sunlight and has on the other surface thereof four pillars, lengths of the four pillars being adjusted by a motor, wherein the apparatus adjusts the length of at least one of the four pillars so as to adjust the reflection angle.

The robot may include a terrestrial magnetism sensor so as to provide the apparatus with information on the direction in which the reflecting plate heads for.

In accordance with another aspect of the present invention, there is provided a method for managing a reflecting plate for a fruit tree, including: storing types and locations of fruit trees grown in a growing area; sensing the amount of sunlight; controlling a robot so that it installs a reflecting plate in the growing area based on at least one of the amount of sunlight, the types and locations; and controlling a reflection angle at which the sunlight is reflected in the reflecting plate based on at least one of the amount of sunlight, the types and locations.

The method may further include: determining whether to install the reflecting plate based on the amount of sunlight.

The method may further include: determining the number and locations of reflecting plates to be installed for each of the types, based on at least one of the amount of sunlight, the types and locations

The controlling of the reflection angle may include controlling the reflection angle based on at least one of a location at which the reflecting plate is installed and a direction in which the reflecting plate heads for, created by the robot using a GPS device.

The controlling of the reflection angle may include controlling the reflection angle based on a direction in which the reflecting plate heads for, created by the robot using a terrestrial magnetism sensor

In accordance with yet another aspect of the present invention, there is provided a reflecting plate for a fruit tree, including: a reflecting part disposed on a surface of the reflecting plate and configured to reflect sunlight; four pillars disposed on the other surface of the reflecting plate, lengths of the four pillars being adjusted by a motor; a central processing unit configured to adjust a length of at least one of the four pillars so as to adjust a reflection angle at which sunlight is reflected, under the control of an apparatus for managing a reflecting plate for a fruit tree using wireless communications.

The lengths of the pillars may be adjusted in a such manner that they move vertically as the motor rotates.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a system for managing a reflecting plate for a fruit tree according to an exemplary embodiment of the present invention;

FIG. 2 is a block diagram of an example of the reflecting plate shown in FIG. 1;

FIG. 3 is a front view of the reflecting plate shown in FIG. 1;

FIG. 4 is a rear view of the reflecting plate shown in FIG. 1;

FIG. 5 is a side view of the reflecting plate shown in FIG. 1;

FIG. 6 is a block diagram of an example of the robot shown in FIG. 1;

FIG. 7 is a block diagram of an example of the server for managing the reflecting plate for a fruit tree shown in FIG. 1 and

FIG. 8 is a flowchart for illustrating a method for managing a reflecting plate for a fruit tree according to an exemplary embodiment of the present invention.

### DESCRIPTION OF THE PREFERRED EMBODIMENTS

Exemplary embodiments of the present invention will be described in detail with reference to the accompanying drawings. Herein, redundant descriptions on the identical elements, and descriptions on known features and configurations which may obscure the gist of the present invention will be omitted. Exemplary embodiments of the present invention are provided to fully convey the principle of the invention to those skilled in the art. In the accompanying drawings, shapes, dimensions and the like of elements may be exaggerated for clarity.

Hereinafter, exemplary embodiments of the present invention will be described in detail with reference to the accompanying drawings.

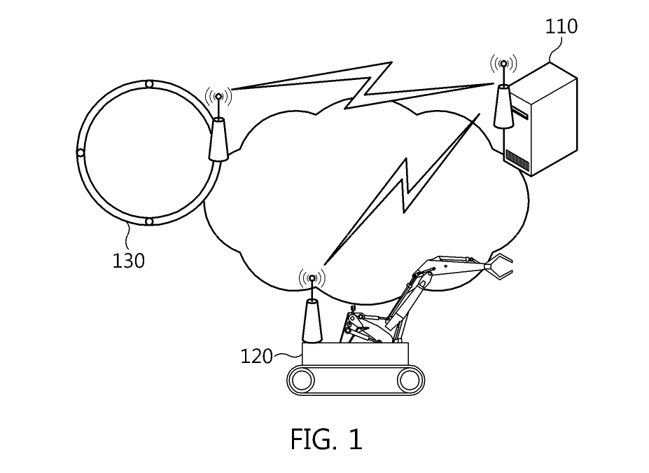

FIG. 1 is a view showing a system for managing a reflecting plate for a fruit tree according to an exemplary embodiment of the present invention.

Referring to FIG. 1, the system for managing a reflecting plate for a fruit tree according to the exemplary embodiment of the present invention includes a server 110 that manages a reflecting plate for a fruit tree, a robot 120 that moves a reflecting plate for a fruit tree, and a reflecting plate 130.

In order to reflect sunlight incident on the surface of the earth to increase sunlight toward fruits, the server 110 controls the robot 120 so that it installs the reflecting plate 130 where a fruit tree is grown and adjusts the angle of the reflecting plate 130 to appropriately reflect sunlight.

The robot 120 receives instructions from the server 110 in a wired or wireless manner to move the reflecting plate 130 to an installation location and installs the reflecting plate 130 so that it heads for an appropriate direction.

Further, the robot 120, under the control of the server 110, may retrieve the reflecting plate 130 from the installation location.

The reflecting plate 130 may have a round shape for easy installation and management, and its height can be adjusted in four cardinal directions and thus the reflection angle can be adjusted. The reflecting plate 130 also receives instructions from the server 110 in a wired or wireless manner.

The reflecting plate 130 may have the feature of wireless communication and the feature of adjusting a reflection angle at which sunlight is reflected.

The robot 120 may have the feature of wireless communication, the feature of moving the reflecting plate 130, and the feature of installing the reflecting plate 130.

The server 110 may have the feature of determining whether to install the reflecting plate 130, the feature of determining where to install the reflecting plate 130, the feature of wirelessly controlling the robot 120 so that it installs the reflecting plate 130 at a determined location, and the feature of wirelessly controlling the reflecting plate 130 so that sunlight is reflected at an appropriate angle to facilitate the growth of a fruit tree.

In order to sufficiently cover a growing area, a plurality of reflecting plates 130 may be provided.

In order to install the plurality of reflecting plates 130 at necessary locations more quickly, a plurality of robots 120 may be provided.

The number of the robots 120 may be less than the number of the reflecting plates 130.

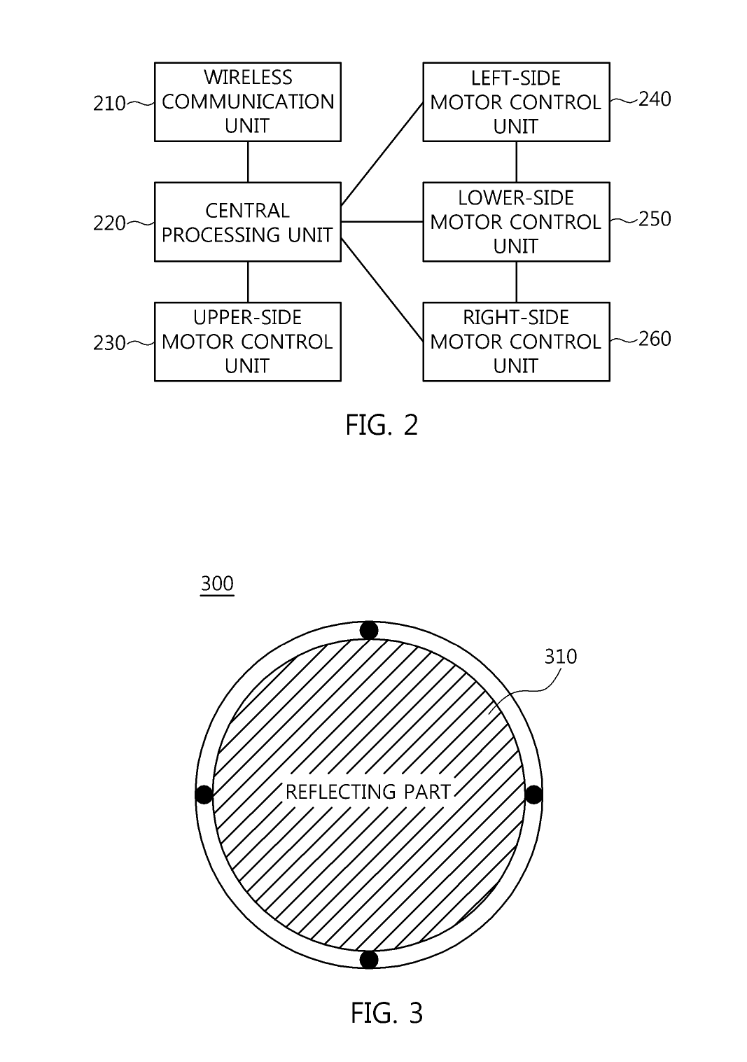

FIG. 2 is a block diagram of an example of the reflecting plate shown in FIG. 1.

Referring to FIG. 2, the reflecting plate 130 shown in FIG. 1 may include a wireless communication unit 210, a central processing unit 220, an upper-side motor control unit 230, a left-side motor control unit 240, a lower-side motor control unit 250, and a right-side motor control unit 260.

The wireless communication unit 210 performs wireless communications with the server 110.

The central processing unit 220 controls the upper-side motor control unit 230, the left-side motor control unit 240, the lower-side motor control unit 250, and the right-side motor control unit 260 based on the wireless communication between the wireless communication unit 210 and the server 110.

The upper-side motor control unit 230, the left-side motor control unit 240, the lower-side motor control unit 250, and the right-side motor control unit 260 control a motor so that the heights of pillars installed under the reflecting plate are adjusted. Specifically, four pillars to adjust the height of the reflecting plate are installed under the reflecting plate, each at a position corresponding to one of the four cardinal directions. By adjusting the lengths of the four pillars, the reflection angle of the reflecting plate can be adjusted.

FIG. 3 is a front view of the reflecting plate 300 shown in FIG. 1.

Referring to FIG. 3, a reflecting part 310 is disposed on the front surface of the reflecting plate.

The reflecting part 310 may be made of various types of material having a high reflection factor so as to reflect sunlight.

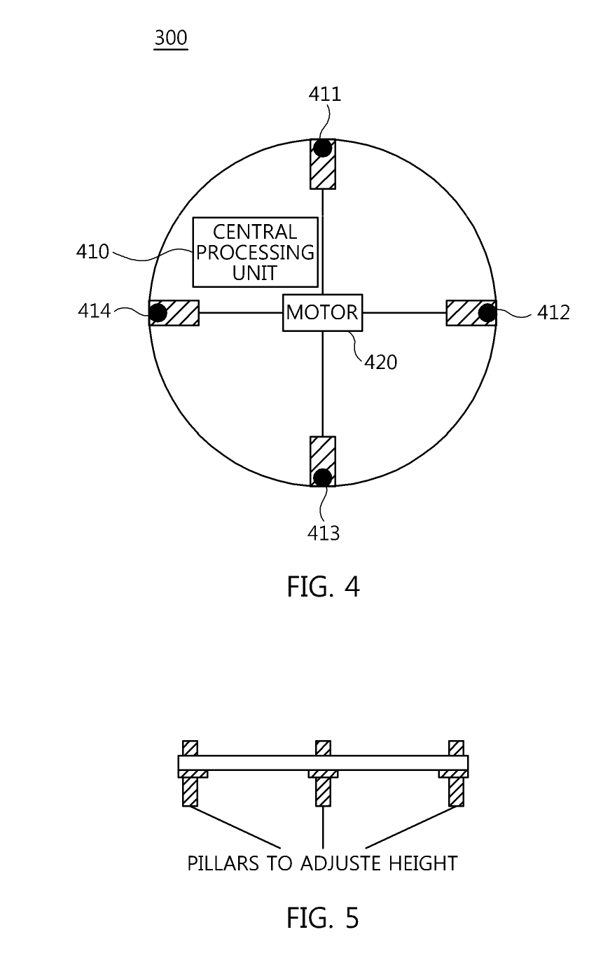

FIG. 4 is a rear view of the reflecting plate 300 shown in FIG. 1.

Referring to FIG. 4, four pillars 411, 412, 413 and 414 to adjust the height of the reflecting plate are disposed on the rear surface of the reflecting plate. The lengths of the pillars are adjusted by a motor 420.

The lengths of the four pillars 411, 412, 413 and 414 are adjusted in a such manner that they move vertically as the motor 420 rotates.

In this regard, the four pillars 411, 412, 413 and 414 may share one motor, each of the four pillars 411, 412, 413 and 414 may have a corresponding one, or at least two of the four pillars 411, 412, 413 and 414 may share one motor.

Each of the four pillars 411, 412, 412 and 414 may be a screwed, circular pillar.

FIG. 5 is a side view of the reflecting plate shown in FIG. 1.

As can be seen from FIG. 5, the reflecting plate has pillars to adjust the height thereunder, and the reflection angle of the reflecting plate is controlled by adjusting the lengths of the pillars.

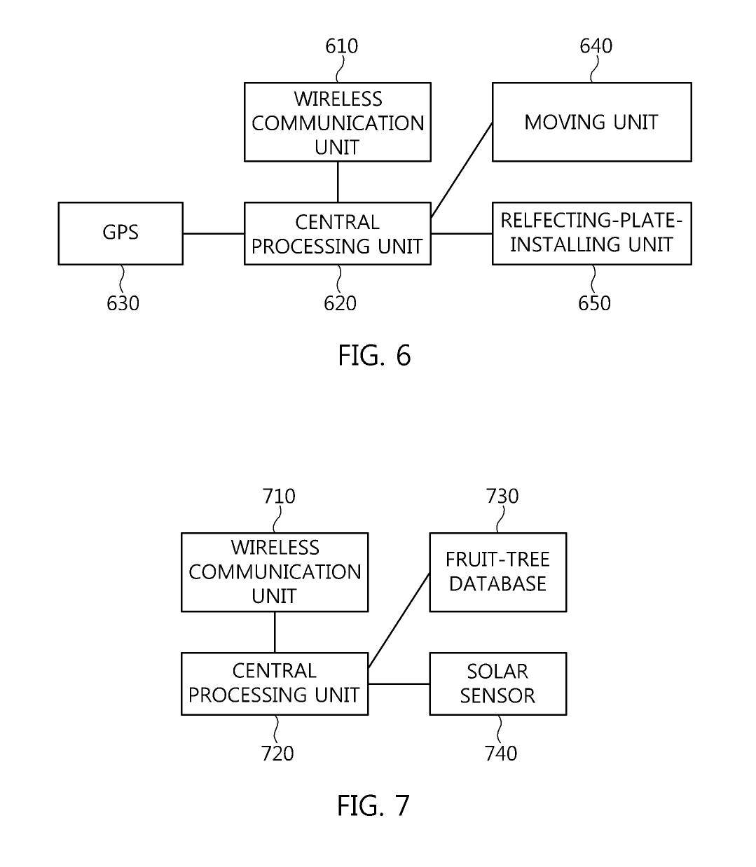

FIG. 6 is a block diagram of an example of the robot shown in FIG. 1.

Referring to FIG. 6, the robot includes a wireless communication unit 610, a central processing unit 620, a GPS device 630, a moving unit 640, and a reflecting-plate-installing unit 650.

The wireless communication unit 610 performs wireless communications with the server 110.

The central processing unit 620 may control the wireless communication unit 610, the GPS device 630, the moving unit 640, and the reflecting-plate-installing unit 650.

The GPS device 630 uses a satellite signal to create location information of the robot. The robot may use the location information created by the GPS device 630 to create information on a location at which the reflecting plate is installed, and a direction in which the reflecting plate heads for, and then may provide it to the server.

Although not shown in FIG. 6, the robot may include a terrestrial magnetism sensor to create information on the direction in which the reflecting plate heads for and may provide it to the server.

The moving unit 640 may move the robot pursuant to the control of the server via the wireless communication unit 610. The moving unit 640 may include one or more wheels or chains.

The reflecting-plate-installing unit 650 may control a robot arm of the robot so that the robot installs the reflecting plate and retrieve it.

FIG. 7 is a block diagram of an example of the server for managing the reflecting plate for a fruit tree shown in FIG. 1.

Referring to FIG. 7, the server shown in FIG. 1 includes a wireless communication unit 710, a central processing unit 720, a fruit-tree database 730, and a solar sensor 740.

The wireless communication unit 710 performs communications with the robot and with the reflecting plate via a wireless communication network.

The robot may collect location information via the GPS receiver and may transmit to the server at least one of a location where the reflecting plate is installed and a direction in which the reflecting plate heads for. The robot may include a terrestrial magnetism sensor to provide the server with the direction in which the reflecting plate heads for.

The solar sensor 740 may sense the amount of sunlight.

The fruit-tree database 730 stores therein the types (varieties) and locations of fruit trees grown in a growing area.

The central processing unit 720 controls the robot so that it installs the reflecting plate in the growing area based on the amount of sunlight, the types and locations and may control the reflection angle at which the sunlight is reflected in the reflecting plate.

The server may determine whether to install the reflecting plate in view of the amount of sunlight. The determining whether to install the reflecting plate may be performed upon receiving an external input.

If the sunlight is stronger than a predetermined value, the server may instruct at least one robot to install the reflecting plate via the wireless communication 710. The robot may obtain a location where the reflecting plate is to be installed from the received instruction and may move to the location to install the reflecting plate. The location of the robot may be created by the GPS device. The robot may transmit to the server the information on the location of the installed reflecting plate, the direction in which the reflecting plate heads for and the like. The installed reflecting plate receives lengths of the pillars to be adjusted from the server so as to adjust the reflection angle of the reflecting plate.

The server may consider at least one of the amount of sunlight, the types and locations in determining the number and locations of reflecting plates to be installed for each of the types. Depending on the number of prepared reflecting plates, the number of varieties of fruit trees for which the reflecting plates are installed may be limited.

The server transmits instructions to adjust the reflection angles of the installed reflecting plates depending on the location of the Sun so that sunlight is provided to fruits as much as possible.

The above-described server for managing the reflecting plate may correspond to an apparatus for managing a reflecting plate defined in the claims.

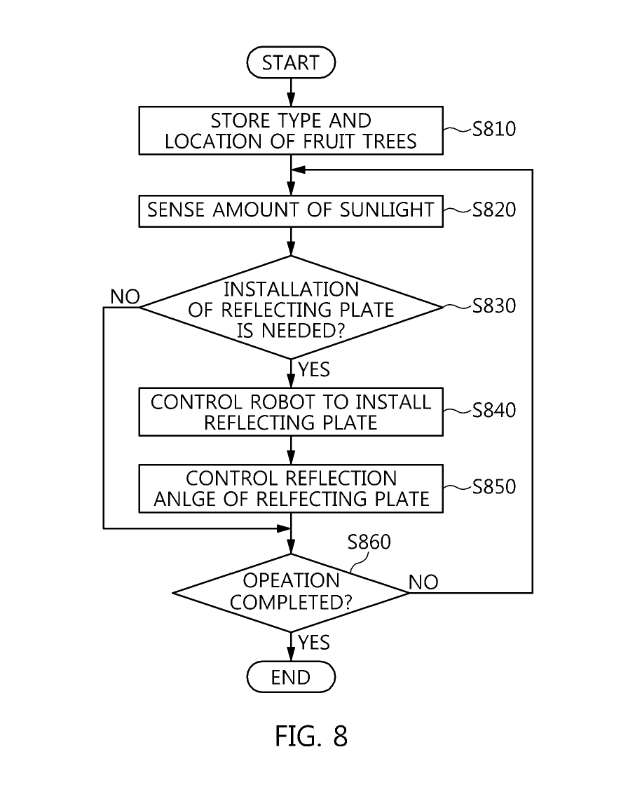

FIG. 8 is a flowchart for illustrating a method for managing a reflecting plate for a fruit tree according to an exemplary embodiment of the present invention.

Referring to FIG. 8, the method for managing a reflecting plate for a fruit tree according to an exemplary embodiment of the present invention may store types and locations of fruit trees gown in a specific growing area in a database (S810).

Further, the method for managing a reflecting plate for a fruit tree according to the exemplary embodiment of the present invention includes sensing the amount of sunlight (S820).

In addition, method for managing a reflecting plate for a fruit tree according to the exemplary embodiment of the present invention includes determining whether to install a reflecting plate (S830).

The determining S830 may be performed based on the amount of sunlight.

Although not illustrated in FIG. 8, the method for managing a reflecting plate for a fruit tree according to the exemplary embodiment of the present invention may further include considering at least one of the amount of sunlight, the types and locations in determining the number and locations of reflecting plates to be installed for each of the types.

If it is determined that a reflecting plate is to be installed in the determining S830, the method for managing a reflecting plate for a fruit tree according to the exemplary embodiment of the present invention controls the robot so that it installs the reflecting plate in the growing area based on at least one of the amount of sunlight, the types and locations (S840).

In addition, the method for managing a reflecting plate for a fruit tree according to the exemplary embodiment of the present invention includes controlling the reflection angle at which the sunlight is reflected in the reflecting plate based on at least one of the amount of sunlight, the types and locations (S850).

The controlling S850 may be performed based on at least one of the installation locations and directions created by the robot using the GPS device.

The controlling S850 may be performed based on the installation direction created by the robot using a terrestrial magnetism sensor.

If it is determined that no reflecting plate is to be installed in the determining S830 or the controlling S850 is completed, the method for managing a reflecting plate for a fruit tree proceeds to determining whether to end the operation (S860).

If it is determined that the operation is to be ended in the determining S860, the method for managing a reflecting plate for a fruit tree ends the operation.

If it is determined that the operation is not to be ended in the determining S860, the method for managing a reflecting plate for a fruit tree returns to the sensing S820.

In accordance with the present invention, the amount of sunlight toward fruits can be efficiently increased by way of efficiently install reflecting plates throughout a broad fruit farm and adjusting the angles of the reflecting plates in accordance with the incident angle of sunlight.

Furthermore, in accordance with the present invention, environmental pollution can be reduced by reusing a reflecting plate used for increasing the amount of sunlight toward fruits.

Moreover, in accordance with the present invention, earnings of fruit farms can be increased by way of saving labor cost required for installing reflecting plates.

Although the apparatus and method for managing a reflecting plate for a fruit tree according to the present invention have been described with reference to exemplary embodiments thereof, the present disclosure is not limited thereby. The above exemplary embodiments may be modified by selectively combining some or all of the exemplary embodiments.

What is claimed is:

1. An apparatus for managing a reflecting plate for a fruit tree, the apparatus comprising:
a solar sensor configured to sense the amount of sunlight;
a fruit-tree database configured to store therein types and locations of fruit trees grown in a growing area;
a wireless communication unit configured to perform communications with a robot for moving a reflecting plate for a fruit tree and with the reflecting plate via a wireless communication network; and
a central processing unit configured to control the robot so that it installs the reflecting plate in the growing area and to control a reflection angle at which the sunlight is reflected in the reflecting plate, based on at least one of the amount of sunlight, the types and locations.

2. The apparatus of claim 1, wherein the apparatus determines whether to install the reflecting plate based on the amount of sunlight.

3. The apparatus of claim 2, wherein the apparatus determines the number and locations of reflecting plates to be installed for each of the types, based on at least one of the amount of sunlight, the types and locations.

4. The apparatus of claim 3, wherein the robot collects location information via a GPS device and transmits to the apparatus at least one of a location where the reflecting plate is installed and a direction in which the reflecting plate heads for.

5. The apparatus of claim 4, wherein the reflecting plate has on a surface thereof a reflecting part to reflect the sunlight and has on the other surface thereof four pillars, lengths of the four pillars being adjusted by a motor, wherein the apparatus adjusts the length of at least one of the four pillars so as to adjust the reflection angle.

6. The apparatus of claim 3, wherein the robot includes a terrestrial magnetism sensor so as to provide the apparatus with information on the direction in which the reflecting plate heads for.

7. A method for managing a reflecting plate for a fruit tree, the method comprising:
storing types and locations of fruit trees grown in a growing area;
sensing the amount of sunlight;
controlling a robot so that it installs a reflecting plate in the growing area based on at least one of the amount of sunlight, the types and locations; and
controlling a reflection angle at which the sunlight is reflected in the reflecting plate based on at least one of the amount of sunlight, the types and locations.

8. The method of claim 7, further comprising: determining whether to install the reflecting plate based on the amount of sunlight.

9. The method of claim 8, further comprising determining the number and locations of reflecting plates to be installed for each of the types, based on at least one of the amount of sunlight, the types and locations.

10. The method of claim 9, wherein the controlling of the reflection angle includes controlling the reflection angle based on at least one of a location at which the reflecting plate is installed and a direction in which the reflecting plate heads for, the location and the direction created by the robot using a GPS device.

11. The method of claim 9, wherein the controlling of the reflection angle includes controlling the reflection angle based on a direction in which the reflecting plate heads for, the direction created by the robot using a terrestrial magnetism sensor.

12. A reflecting plate for a fruit tree, comprising:
a reflecting part disposed on a surface of the reflecting plate and configured to reflect sunlight;
four pillars disposed on the other surface of the reflecting plate, lengths of the four pillars being adjusted by a motor; and
a central processing unit configured to adjust a length of at least one of the four pillars so as to adjust a reflection angle at which sunlight is reflected, under the control of an apparatus for managing a reflecting plate for a fruit tree using wireless communications.

13. The reflecting plate of claim 12, wherein the apparatus controls a robot so that it installs the reflecting plate in a growing area and controls the reflection angle of the installed reflecting plate, based on at least one of the amount of sunlight, the types and locations of fruit tress grown in the growing area.

14. The reflecting plate of claim 13, wherein the lengths of the pillars are adjusted in a such manner that they move vertically as the motor rotates.
